(19) United States
(12) Patent Application Publication
(10) Pub. No.: US 2007/0037050 A1
(43) Pub. Date: Feb. 15, 2007

(54) THERMAL CONTROL DEVICE

(75) Inventors: Gerard Rigobert, Fargues St Hilaire (FR); Malik Beldjoudi, Toulouse (FR)

Correspondence Address: SUGHRUE MION, PLLC, 2100 PENNSYLVANIA AVENUE, N.W., SUITE 800, WASHINGTON, DC, 20037, US

(73) Assignee: SAFT, Bagnolet (FR)

(21) Appl. No.: 11/458,528

(22) Filed: Jul. 19, 2006

(30) Foreign Application Priority Data
Jul. 22, 2005 (FR) 05 07 821

(51) Int. Cl. H01M 10/50; F28F 7/00

(52) U.S. Cl. 429/120; 165/46; 165/83

(57) ABSTRACT

A thermal control device for a plurality of chambers comprising a flexible pouch (1) comprising at least one partition (4) delimiting at least two sections (4a, 4b) of a circulation path of a heat transfer fluid, one section being in contact with at least two chambers (5). The invention lies in the discovery that the presence of partitions in the pouch allows for greater rigidity of the pouch and improved temperature control of the battery cells. The invention extends to the manufacturing method for such a device.

### FIELD OF THE INVENTION

The invention relates to a device designed to control the temperature of a plurality of chambers. This device allows for improved control of the temperature of the chambers and a reduction in the temperature differences between them. These chambers may in particular be made up of the casings of the electrochemical cells of a battery.

### STATE OF THE ART

A battery (or electrochemical generator, these two terms being equivalent) conventionally comprises one or more electrochemical cells. It is generally designed to function within a temperature range known as the nominal range. Using a battery outside this temperature range may result in a limitation of its performance or reduced battery life. For example, charging performed at too low a temperature may result in the battery being insufficiently charged. Charging or discharging at an excessively high temperature may result in rapid deterioration of the components of the battery. Even when used within the nominal temperature range, a battery operating at high power over a long period generates a large amount of heat. If this heat is not sufficiently dissipated by the ambient air, thermal runaway of the battery, or even explosion, may occur.

It is therefore necessary to provide for a thermal control device that will allow for either the heating or cooling of the cells of a battery.

Documents WO 02/07249, JP 11-054157, U.S. Pat. No. 6,228,524 and U.S. Pat. No. 5,624,003 describe temperature control devices made up of a water jacket comprising a rigid enclosure in which a heat transfer fluid circulates. This enclosure is placed in contact with the wall of the battery cells for which temperature control is required. Circulation of the heat transfer fluid is performed by a pump. The water jacket is generally connected to a thermostatic bath that allows for the cells to be heated or cooled, as applicable.

Document EP-A-1261065 describes a water jacket in flexible plastic material. This flexible jacket conforms precisely to the contour of the battery cells. Thermal exchange is thus promoted. However, this device is difficult to implement on an industrial scale due to the long route of the water jacket round the cells. Also, the cells located at the two ends of the cooling device may have different temperatures due to the heating (or cooling) of the heat transfer fluid resulting from its passage in contact with the cells. This temperature difference is even more marked if the battery comprises a large number of cells.

There is therefore a need for a temperature control device that solves the problems mentioned above, and in particular a device offering:
good thermal contact between the heat transfer fluid and the walls of the battery cells in order to obtain a high level of thermal exchange;
reduced temperature differences between the battery cells;
good mechanical rigidity.

### SUMMARY OF THE INVENTION

To this end, the invention proposes a thermal control device for a plurality of chambers comprising a flexible pouch comprising at least one partition delimiting at least two sections of a circulation path of a heat transfer fluid, one section being in contact with at least two chambers. The invention lies in the discovery that the presence of partitions in the pouch allows for greater rigidity of the pouch and improved temperature control of all the chambers.

The invention extends to the manufacturing method for a device of this type. This method comprises stages consisting of:
a) supplying two sheets of a flexible material;
b) welding the edges of the two sheets to form a flexible pouch, leaving at least two sections of the edge unwelded to allow the inlet and outlet of a heat transfer fluid;
c) creating at least one partition in the flexible pouch to delimit at least two sections of a circulation path of the heat transfer fluid.

### BRIEF DESCRIPTION OF THE FIGURES

FIG. 1 is a diagrammatic representation of a flexible pouch according to the invention.

FIG. 2 is a diagrammatic representation of the position of the flexible pouch according to the invention in relation to the cells of a battery.

FIG. 3 shows the temperature variation of the cells of a battery used in successive charge-discharge cycles. These cells are cooled by the thermal control device according to the invention.

FIG. 4 shows the temperature variation in the cells of a battery used in successive charge-discharge cycles. These cells are cooled by a thermal control device that does not form part of the invention.

### DETAILED DESCRIPTION OF THE EMBODIMENTS OF THE INVENTION

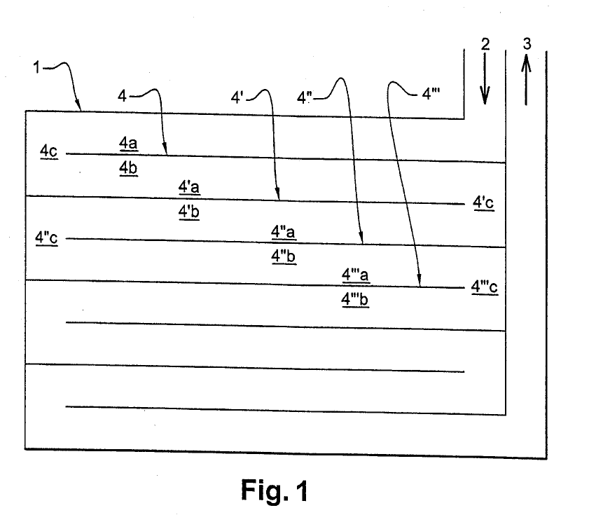

The thermal control device according to the invention will now be described with reference to FIG. 1. This device comprises a flexible pouch of a parallelepiped shape (1), two conduits (2) and (3) for the inlet and the outlet of a heat transfer fluid, and a plurality of partitions that are approximately parallel (4, 4′, 4″, 4″′, etc.) delimiting a circulation path for the heat transfer fluid.

Each partition delimits two sections (4a) and (4b) of the circulation path for the heat transfer fluid. In FIG. 1, the pouch has a parallelepiped shape and the partitions are approximately parallel. However, the invention is not limited to a pouch of this shape and the partitions may have one or more curved portions.

The flexible pouch may be made from a plastic material, chosen from the group comprising polyvinyl chloride or polyurethane. The use of polyvinyl chloride or polyurethane allows for a flexible pouch to be produced, having a thin wall approximately 0.1 mm to 2 mm thick, depending on the nature of the polymer used.

The use of a flexible plastic material allows for the thickness of the flexible pouch to be reduced in order to ensure a high level of thermal exchange between the heat transfer fluid and the wall of the chambers in contact with the flexible pouch. A flexible polyurethane pouch with a thickness of approximately 0.1 mm to 2 mm is nevertheless able to resist a pressure of the heat transfer fluid of approximately 1 bar. The flexibility of the pouch and its thinness allow the pouch to conform closely to the format and arrangement of the chambers.

The thermal control device may be connected to a thermostatic bath in order to control the temperature of the heat transfer fluid. The fluid is supplied by a pump to the inlet conduit (2). It passes through the void of the flexible pouch, circulating along the sections defined by the partitions. The fluid leaves the pouch by the outlet conduit (3).

The circulation of the heat transfer fluid inside the flexible pouch will now be described.

In the example in FIG. 1, the partitions are aligned along the length of the pouch, extending over practically the whole length of the pouch. The inlet and outlet conduits (2) and (3) are adjacent. This arrangement facilitates the connection of the flexible pouch to a thermostatic bath.

The heat transfer fluid enters the flexible pouch via the inlet conduit (2). It circulates along the section (4a) and reaches the region (4c) corresponding to a gap in the partition (4). In this region, the direction of circulation of the fluid changes. The fluid then circulates along section (4b) towards the region (4′c) corresponding to a gap in the partition (4′). The presence of gap zones in the partition therefore allows for a change in the direction of circulation of the heat transfer fluid. The heat transfer fluid continues its route through the following sections, and then leaves the pouch by the conduit (3).

The position of the flexible pouch in relation to the plurality of chambers for which temperature control is required will now be described. No limitations are placed on the dimensions, format and material of each of the chambers. The chambers may have identical or different formats, identical or different dimensions, and be made up of identical or different materials. The position of the flexible pouch in relation to a plurality of chambers, made up of the casings of the cells of a battery, will be detailed below. The term “chamber” thus denotes the casing of a battery cell.

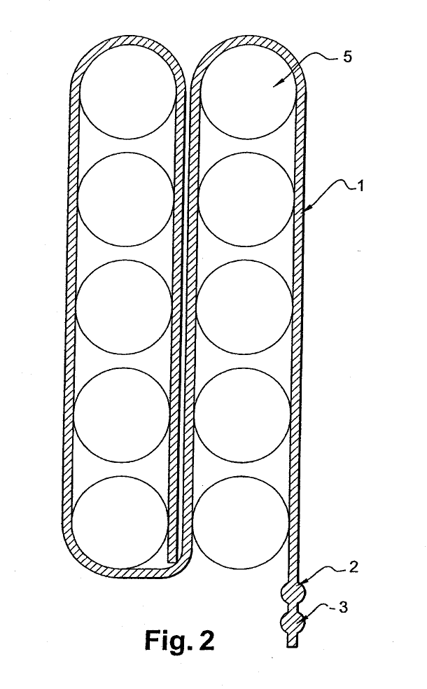

FIG. 2 illustrates the position of the flexible pouch (1) in relation to the chambers (5). The chambers have a cylindrical format and identical dimensions, and are arranged in two rows. The width of the flexible pouch is approximately equal to the height of the chambers. The length of the flexible pouch is wound round the first row of chambers, then round the second row of chambers.

The length of a partition is chosen in such a way that the sections located on each side of this partition are in contact with at least two chambers. In a preferred embodiment, one section is in contact with all the chambers.

The presence of several partitions allows for at least two sections that have no partition in common to be in contact with the same chamber. These partitions may be distributed equally over the height of the chamber.

The presence of partitions allows the heat transfer fluid to pass once in contact with several chambers and to pass several times in contact with a single chamber.

The presence of partitions has the advantage of reducing the temperature variations between the chambers located at the two ends of the length of the flexible pouch.

In document EP-A-1261065, the heat transfer fluid passes only once in contact with all the chambers. The chambers located at the two ends of the cooling device may have different temperatures as a result of the gradual heating of the heat transfer fluid caused by the contact of the fluid with each chamber.

In the device according to the invention, the heat transfer fluid accumulates less heat during its route between the two endmost chambers. The device according to the invention thus allows for a smaller temperature difference between the chambers located at the two ends of the cooling device to be obtained.

The presence of partitions has a further advantage: it allows for the mechanical rigidity of the flexible pouch to be increased in comparison with a flexible pouch that does not have partitions. The pouch is thus easily positioned in contact with the electrochemical cells.

The device according to the invention also offers other advantages:
it does not generate head loss;
it is flexible and thus adapts to different configurations of chambers.

The thermal control device according to the invention may be manufactured as follows:
a) two sheets of a flexible material are supplied;
b) the edges of the two sheets are welded to form a flexible pouch, leaving at least two portions of the edge unwelded to allow the inlet and outlet of a heat transfer fluid;
c) at least one partition is created in the flexible pouch to delimit at least two sections of a circulation path of the heat transfer fluid.

In one embodiment, the partition is formed by welding. Preferably, the welding in stages b) and c) is high-frequency welding.

According to one characteristic, the flexible material used in the method according to the invention is a plastic material, chosen from the group comprising polyvinyl chloride or polyurethane.

The device according to the invention is well suited to controlling the temperature of sealed battery cells such as the cells of a lithium-ion type battery. The latter generate a large amount of energy when they operate in a high-current charge or discharge mode, as is the case for hybrid propulsion vehicles having a thermal combustion engine and an electric motor.

### EXAMPLES

A first thermal control device according to the invention has been manufactured as follows. A flexible pouch was made by high-frequency welding of the edges of two polyurethane sheets. Three parallel partitions were manufactured by high-frequency surface welding of the two polyurethane sheets.

Ten cylindrical cells of a lithium-ion battery charged to 60% of their nominal capacity were arranged in two rows of five cells, and the electrical connections between the cells were made.

The flexible pouch was arranged in such a way as to wrap round the first row of five cells and then the second row. The heat transfer fluid thus performs a total of two passes in each direction, i.e. four passes in contact with any given cell.

A second thermal control device that does not form part of the invention was arranged in the same way around ten cylindrical battery cells arranged in two rows of five cells. This device comprised a rigid pouch without partitions.

The cells underwent a cycling test comprising successive charges and discharges between approximately 3.45 V and 3.9 V at an ambient temperature of 25° C. These operating conditions cause heat to be generated in the cells and the temperature control device is used to cool them.

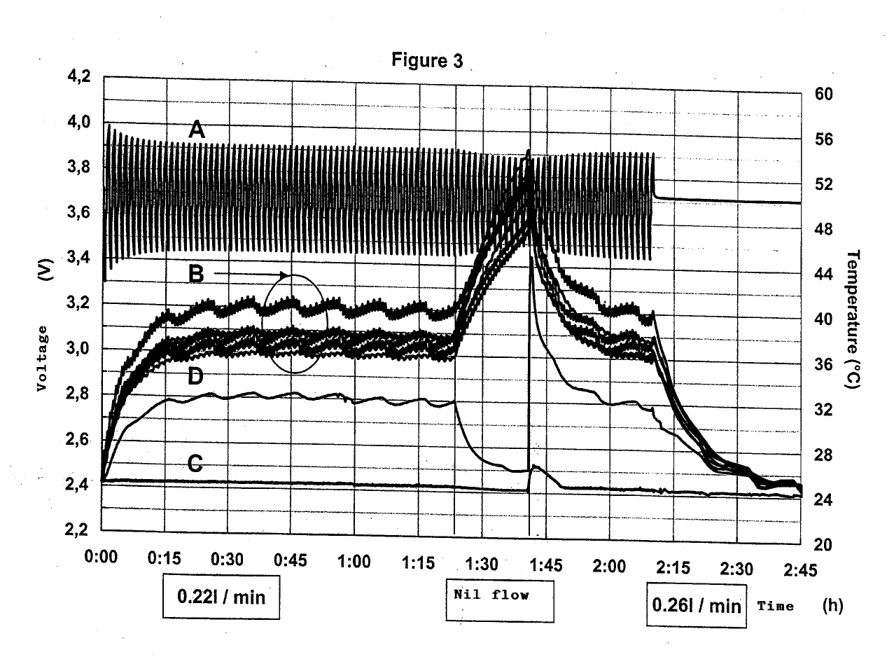

The heat transfer fluid was circulated in the thermal control device by means of a pump. Its flow rate was set at 0.221/min until approximately 1 hr 20 min after the start of the test. It was nil from 1 hr 20 min to 1 hr 40 min, and then it was 0.261/min until the end of the test (FIG. 3).

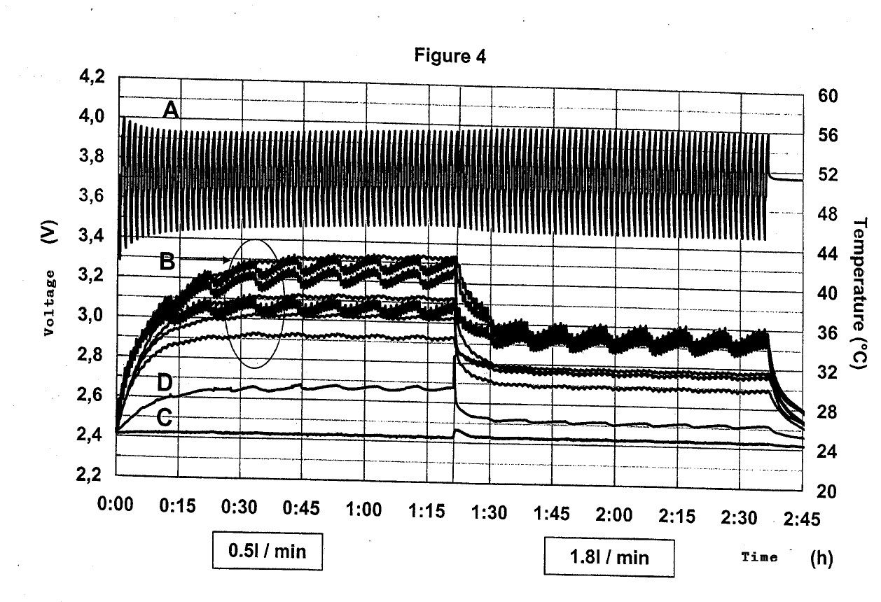

The flow rate of the heat transfer fluid in the thermal control device that does not form part of the invention was set at 0.501/min until approximately 1 hr 20 min after the start of the test, and then it was set at 1.81/min until the end of the test (FIG. 4).

During the course of the test, the following measurements were taken:
the voltage of one of the cells (curve A);
the temperature of the cells and the connections (group of curves B);
the water temperature at the inlet to the pouch (curve C);
the water temperature at the outlet from the pouch (curve D).

It will be noted that the temperatures of the cells and the connections cooled by the device according to the invention range from 36° to 40° C. at a flow rate of 0.22 or 0.261/min, while the temperatures of the cells and the connections cooled by the device that does not form part of the invention range from 34° to 42° C. at a flow rate of 0.51/min, with the flow rate of 0.51/min being in principle more favourable to proper cooling of the cells.

These results show firstly, that the temperatures of the cells and the connections cooled by the device according to the invention have a more narrow range than the temperatures of the cells and the connections cooled by the device that does not form part of the invention (36-40° C. instead of 34-42° C.). They also show that the maximum temperature recorded is lower in the case of the cells cooled by the device according to the invention (40° C. instead of 42° C. for the device that does not form part of the invention, with a higher flow rate of heat transfer fluid).

This embodiment and the figures must be considered as illustrative and not restrictive, and the invention is not necessarily limited to battery cells. In particular, the invention may also be applied to control the temperature of any chamber requiring temperature control such as for example a chamber in a chemical reactor.

1. Thermal control device for a plurality of chambers, comprising a flexible pouch (1) comprising at least one partition (4) delimiting at least two sections (4a, 4b) of a circulation path of a heat transfer fluid, one section being in contact with at least two chambers (5).

2. The device according to claim 1, in which one section is in contact with all the chambers.

3. The device according to claim 1, in which at least two sections that have no partition in common are in contact with the same chamber.

4. The device according to claim 1, in which the flexible pouch is made from a plastic material.

5. The device according to claim 4, in which the plastic material is chosen from the group comprising polyvinyl chloride or polyurethane.

6. The device according to claim 1, in which one or more chambers are cells of a battery.

7. Manufacturing method for a thermal control device for a plurality of chambers, comprising stages consisting of:
a) supplying two sheets of a flexible material;
b) welding the edges of the two sheets to form a flexible pouch, leaving at least two portions of the edge unwelded to allow the inlet and outlet of a heat transfer fluid;
c) creating at least one partition in the flexible pouch to delimit at least two sections of a circulation path of the heat transfer fluid.

8. The method according to claim 7, in which the partition is made by welding.

9. The method according to claim 8, in which the welding of stages b) and c) is high-frequency welding.

10. The method according to claim 7, in which the flexible pouch is made from a plastic material.

11. The method according to claim 10, in which the plastic material is chosen from the group comprising polyvinyl chloride or polyurethane.

12. The device according to claim 1, obtained by the method according to claim 7.

13. Use of a thermal control device for regulating the temperature of a plurality of chambers, the device comprising a flexible pouch (1) comprising at least one partition (4) delimiting at least two sections (4a, 4b) of a circulation path of a heat transfer fluid, the pouch being arranged in such a way that one section is in contact with at least two chambers (5).

14. The use of the device according to claim 13, in which one section is in contact with all the chambers.

15. The use of the device according to claim 13, in which at least two sections that have no partition in common are in contact with the same chamber.

16. The use of the device according to claim 13, to control the temperature of the cells of a battery.
